(19) United States
(12) Patent Application Publication
(10) Pub. No.: US 2025/0033225 A1
(43) Pub. Date: Jan. 30, 2025

(54) SYSTEMS AND METHODS FOR PROVIDING MODULAR ARCHITECTURES FOR ROBOTIC END EFFECTORS

(71) Applicant: Boston Dynamics, Inc., Waltham, MA (US)

(72) Inventors: Joshua Geating, Boston, MA (US); Christopher Thorne, Waltham, MA (US); Alexander Jenko, Somerville, MA (US); Faruk Bursal, Lexington, MA (US); Nickolas Demas, Arlington, MA (US); Beth Baniszewski, Cambridge, MA (US)

(21) Appl. No.: 18/359,349

(22) Filed: Jul. 26, 2023

(51) Int. Cl. B25J 15/06; B65G 47/91

(52) U.S. Cl. CPC B25J 15/0683; B25J 15/0633; B65G 47/91

(57) ABSTRACT

A robotic gripper includes a first modular component comprising a set of deformable members, such as a set of vacuum cups or foam members. The robotic gripper also includes a second modular component comprising a set of vacuum valves. Each vacuum valve in the set of vacuum valves is fluidly connected to at least one deformable member in the set of deformable members.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

Robots may be configured to grasp objects (e.g., boxes or other parcels) and move them from one location to another using, for example, a robotic arm with an end effector (e.g., a vacuum-based gripper). For instance, the robotic arm may be positioned such that one or more deformable members (e.g., vacuum cups, such as rubber suction cups, or foam members) of the gripper are in contact with, or are near, a face of an object to be grasped. A vacuum system (e.g., on board the robot) may then be activated to use suction to adhere the object to the gripper and/or deactivated to release the object.

Robotic grippers that use vacuum are typically highly integrated devices. As a result, servicing robotic grippers and/or creating varying gripper configurations (e.g., different arrays of vacuum cups, which may differ in position, size, shape, and/or material) can be cumbersome. The inventors have recognized and appreciated that robotic gripper architectures can be improved by segregating certain structures used to support different functions into separate modules that are easier to replace and/or repair independently.

A robotic vacuum gripper may include a rigid outer structure, a center hub and/or wrist connection (e.g., to pass electrical signals, power and/or vacuum), a vacuum distribution plenum, vacuum valves, electronic components, air distribution channels, and a set of deformable members (e.g., vacuum cups) for contacting objects. In some embodiments, a vacuum gripper can be enhanced by measuring vacuum pressure in the plenum and/or in each vacuum cup (or vacuum cup zone, corresponding to one or more vacuum cups) so that vacuum cups that do not have a good seal against the object being lifted can be selectively turned off, thereby saving vacuum power and/or maximizing the grip strength of the vacuum cups with adequate seals.

In some embodiments, a robotic vacuum gripper includes an integrated configuration of vacuum valves. Previously, vacuum valves have been co-located with the cups they control (and/or the pressure sensors associated therewith). In some embodiments, the vacuum valves can be built directly into a modular component (e.g., a valve manifold). In some embodiments, the modular component comprises a monolithic component (or multiple monolithic components) that holds the valves (e.g., packed tightly together in space) and/or is serviceable independently of other parts of the system. The modular component can interface to the center hub (and/or wrist connection), which can pass vacuum to the modular component (e.g., from a vacuum source).

In some embodiments, one or more pressure sensors (e.g., included in one or more circuit boards) are also included in the modular component. For instance, each pressure sensor can be positioned relative to (e.g., above) a respective opening that is connected to a corresponding vacuum valve. Each pressure sensor can measure a vacuum pressure downstream from the respective valve. In addition, an opposite side of the modular component can have a separate set of openings leading out from the same valves. In some embodiments, another modular component (e.g., a separate distribution manifold) can interface to the modular component (e.g., directly or indirectly). In some embodiments, the other modular component can channel the output of each vacuum valve to a corresponding deformable member, such as a vacuum cup or a foam member.

By adopting a modular approach, the arrangement of deformable members can be made independent of the arrangement of vacuum valves. As a result, a different array of deformable members can be utilized by simply changing out one modular component for another, without affecting the valves or the overall structure of the gripper. In addition, the platform of the array of deformable members can be enlarged, shrunk, reshaped and/or rearranged to better fit the type of object being lifted. In practice, this capability can be advantageous because it is often unclear what arrangement of deformable members will best suit a particular type of load before a real-world attempt is made (let alone a range of loads that the same gripper might be tasked with lifting). It can also be unpredictable when different parts of the gripper might fail during operation. By adopting a modular approach, failures can be isolated to specific modular components, which can be replaced and/or repaired individually, minimizing down time and/or compartmentalizing failure risk.

In one aspect, the invention features a robotic gripper. The robotic gripper includes a first modular component comprising a set of deformable members. The robotic gripper also includes a second modular component comprising a set of vacuum valves. Each vacuum valve in the set of vacuum valves is fluidly connected to at least one deformable member in the set of deformable members. In some embodiments, the set of deformable members comprises a set of vacuum cups. In some embodiments, the set of deformable members comprises a set of foam members.

In some embodiments, the first modular component comprises a set of channels. In some embodiments, each channel in the set of channels defines, at least in part, a fluid connection between at least one vacuum valve in the set of vacuum valves and at least one deformable member in the set of deformable members. In some embodiments, each channel in the set of channels is defined, at least in part, by a monolithic member having a first surface, a second surface opposite the first surface, and a set of bores. In some embodiments, each deformable member in the set of deformable members is mounted to confine a mounting member. In some embodiments, the mounting member contacts the monolithic member at a bottom surface of the monolithic member.

In some embodiments, the robotic gripper comprises a connector configured to pass vacuum from a vacuum source. In some embodiments, the connector defines, at least in part, a fluid connection directly to the second modular component. In some embodiments, the connector defines, at least in part, a fluid connection to a recessed region of the first modular component. In some embodiments, the recessed region of the first modular component is fluidly connected to the second modular component. In some embodiments, the connector is configured to pass at least one of electrical signals or electrical power to one or more components of the robotic gripper.

In some embodiments, the robotic gripper comprises a controller configured to individually control an amount of vacuum supplied by each vacuum valve in the set of vacuum valves. In some embodiments, each vacuum valve in the set of vacuum valves is configured to actuate to adjust an amount of vacuum in the vacuum valve. In some embodiments, the robotic gripper comprises a set of control valves. In some embodiments, each control valve is fluidly connected to, and/or configured to actuate, a respective vacuum valve in the set of vacuum valves to adjust an amount of vacuum in the vacuum valve.

In some embodiments, the robotic gripper comprises a set of pressure sensors. In some embodiments, each pressure sensor in the set of pressure sensors is configured to sense a pressure associated with (i) a respective vacuum valve in the set of vacuum valves, and/or (ii) a respective vacuum zone or deformable member. In some embodiments, each pressure sensor in the set of pressure sensors is electrically connected to a common circuit board. In some embodiments, each pressure sensor in the set of pressure sensors is mounted above a respective vacuum valve in the set of vacuum valves.

In some embodiments, the second modular component includes a structural member configured to hold each vacuum valve in the set of vacuum valves. In some embodiments, each vacuum valve in the set of vacuum valves is fluidly connected to one corresponding deformable member in the set of deformable members. In some embodiments, each vacuum valve in the set of vacuum valves is fluidly connected to at least two corresponding deformable members in the set of deformable members. In some embodiments, each vacuum valve in the set of vacuum valves is fluidly connected to at least three corresponding deformable members in the set of deformable members.

In some embodiments, the robotic gripper comprises at least two groups of deformable members. In some embodiments, deformable members in the first group of deformable members differ from deformable members in the second group of deformable members in at least one of size, shape, or material.

In some embodiments, the invention includes a robot. The robot includes a mobile base. The robot also includes a robotic arm coupled to the mobile base. The robot also includes a robotic gripper (e.g., as set forth above). In some embodiments, the robotic gripper is coupled to a distal end of the robotic arm.

In another aspect, the invention features a method of using a robotic gripper. The method includes providing vacuum to a robotic gripper. The robotic gripper comprises a first modular component comprising a set of deformable members. The robotic gripper comprises a second modular component comprising a set of vacuum valves. Each vacuum valve in the set of vacuum valves is fluidly connected to at least one deformable member in the set of deformable members. The method also comprises routing vacuum through the set of vacuum valves to the set of deformable members.

In some embodiments, the method comprises lifting an object using the robotic gripper by establishing a vacuum seal between the object and at least one deformable member in the set of deformable members, and controlling a robotic arm coupled to the robotic gripper to lift the object while the vacuum seal is established.

In some embodiments, the method comprises individually controlling each vacuum valve in the set of vacuum valves. In some embodiments, routing vacuum through the set of vacuum valves to the set of deformable members comprises routing vacuum from a vacuum source to the set of vacuum valves via a connector of the robotic gripper; and/or routing vacuum from the set of vacuum valves to the set of deformable members via a set of channels defined, at least in part by the first modular component.

In some embodiments, the method comprises applying a vacuum pulse to each vacuum valve in the set of vacuum valves. In some embodiments, the method comprises determining, for each of the vacuum valves, while the vacuum pulse is applied to the vacuum valve and using one or more pressure sensors, a pressure measurement for the vacuum valve. In some embodiments, the method comprises selectively activating one or more of the vacuum valves based, at least in part, on the determined pressure measurements for the vacuum valves.

In some embodiments, the method comprises determining a trajectory for the robotic gripper based at least in part on the determined pressure measurements for the vacuum valves. In some embodiments, the pressure measurement comprises a rate of change of a pressure signal measured by the one or more pressure sensors and/or a peak pressure value of a pressure signal measured by the one or more pressure sensors. In some embodiments, the pressure measurement comprises a time-variant pressure signal measured by the one or more pressure sensors.

In another aspect, the invention features a method of servicing a robotic gripper. The method includes providing a robotic gripper. The robotic gripper comprises a first modular component comprising a set of deformable members. The robotic gripper also comprises a second modular component comprising a set of vacuum valves. Each vacuum valve in the set of vacuum valves is fluidly connected to at least one deformable member in the set of deformable members. The method also includes removing one of the first modular component or the second modular component from the robotic gripper for individual service.

In some embodiments, the flexibility afforded by the modular approach allows for the simultaneous use of different types of deformable members, e.g., those that have different diameters, heights, or number of bellows. As such, “hybrid” grippers can be constructed (e.g., grippers that have different regions optimized for picking different types of objects). As an example, a periphery of a gripper planform can utilize large and/or stiff deformable members to increase a moment-carrying capacity of the gripper, and a central region can utilize smaller and/or softer deformable members to better conform to uneven load surfaces. In some embodiments, a distribution manifold is placed to the side of the valve manifold(s) (rather than underneath), so as to create a thin (e.g., spatula-like) gripper that can fit into tight spaces (e.g., underneath warehouse racks or inside shipping containers). In some embodiments, a distribution manifold is segmented into discrete planforms.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a perspective view of a robot, according to an illustrative embodiment of the invention.

FIG. 4A is a schematic illustration of a modular vacuum gripper, according to an illustrative embodiment of the invention.

FIG. 4B is a schematic illustration of another modular vacuum gripper, according to an illustrative embodiment of the invention.

FIG. 5 is a schematic illustration of another modular vacuum gripper, according to an illustrative embodiment of the invention.

FIG. 6 is an exploded schematic illustration of a first modular component (e.g., a distribution manifold) for a modular vacuum gripper, according to an illustrative embodiment of the invention.

FIG. 7A is a perspective view schematic illustration of a second modular component (e.g., a valve manifold) for a modular vacuum gripper, according to an illustrative embodiment of the invention.

FIG. 7B is a side view schematic illustration of a second modular component (e.g., a valve manifold) for a modular vacuum gripper, according to an illustrative embodiment of the invention.

FIG. 8 is a schematic illustration of another modular vacuum gripper, according to an illustrative embodiment of the invention.

FIG. 9 is a schematic illustration of an underside of a modular vacuum gripper having different types of vacuum cups, according to an illustrative embodiment of the invention.

FIG. 10 is a schematic illustration of a cup arrangement on an underside of another modular vacuum gripper having different types of vacuum cups, according to an illustrative embodiment of the invention.

FIGS. 11A-11D are schematic illustrations of possible cup arrangements of different types of vacuum cups for a modular vacuum gripper, according to an illustrative embodiment of the invention.

FIG. 12 illustrates an example configuration of a robotic device, according to an illustrative embodiment of the invention.

FIG. 13 shows a flow chart of a method of using a robotic gripper, according to an illustrative embodiment of the invention.

FIG. 14 shows a flow chart of a method of servicing a robotic gripper, according to an illustrative embodiment of the invention.

### DETAILED DESCRIPTION

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

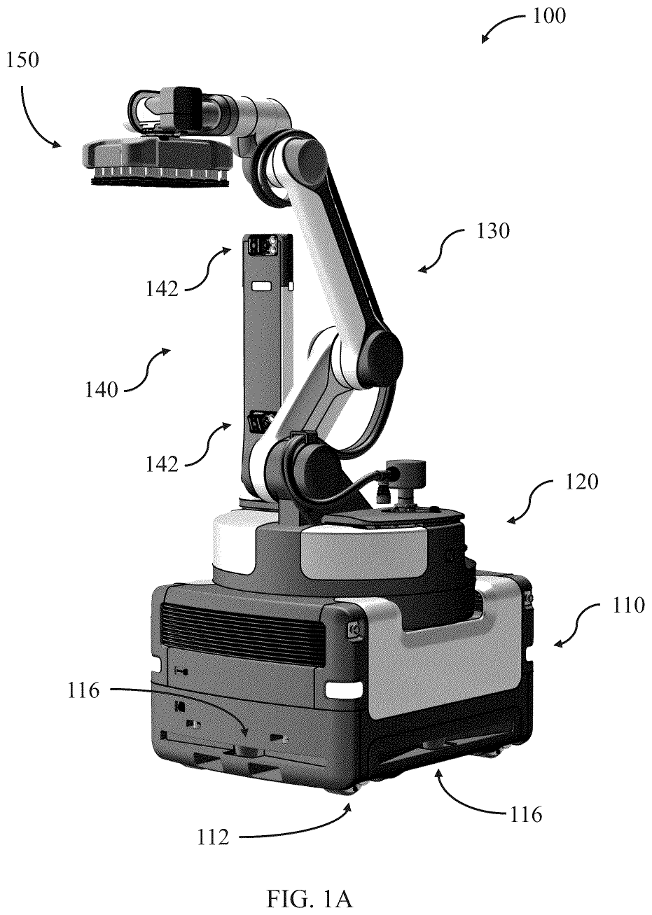

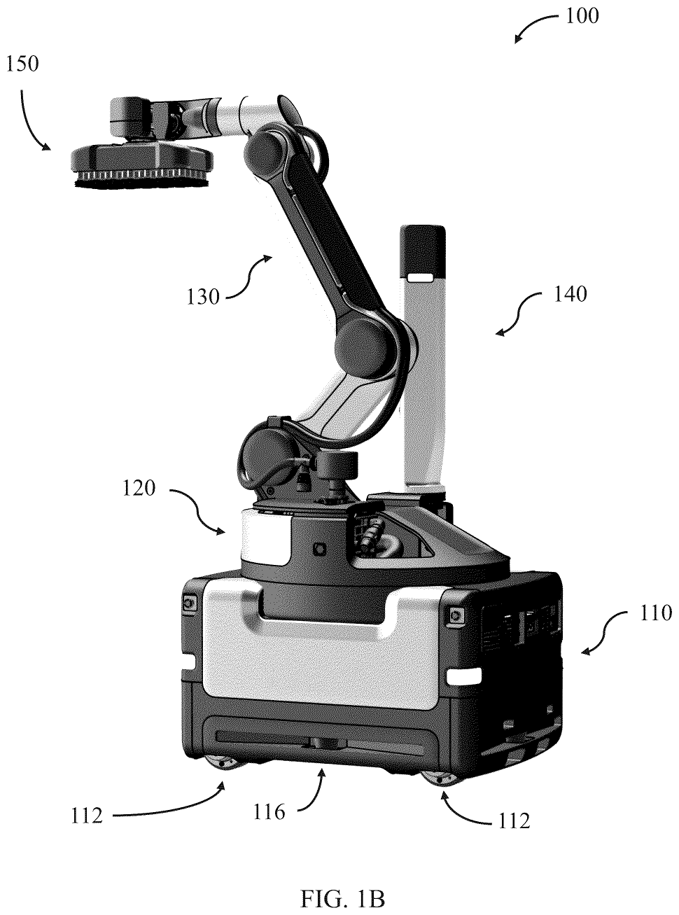

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

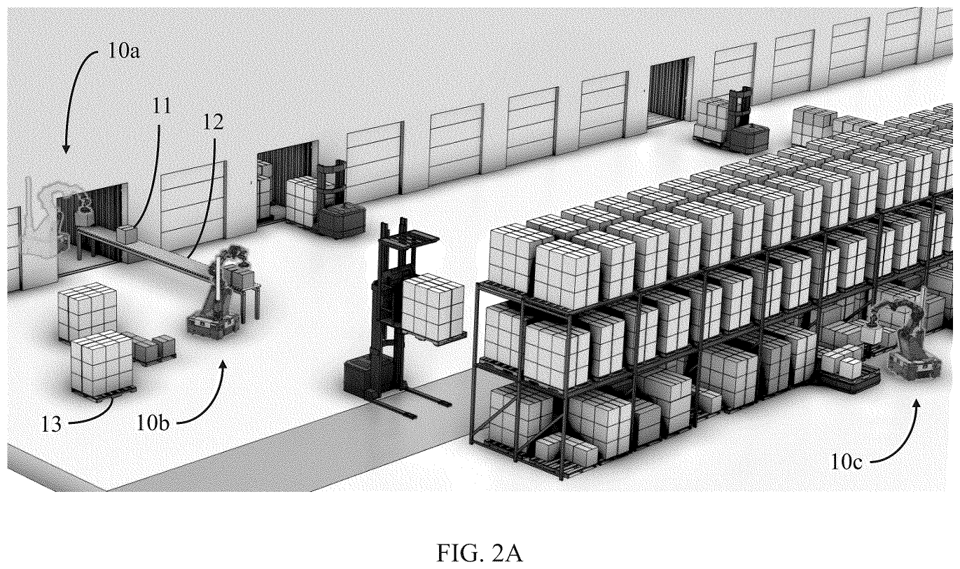

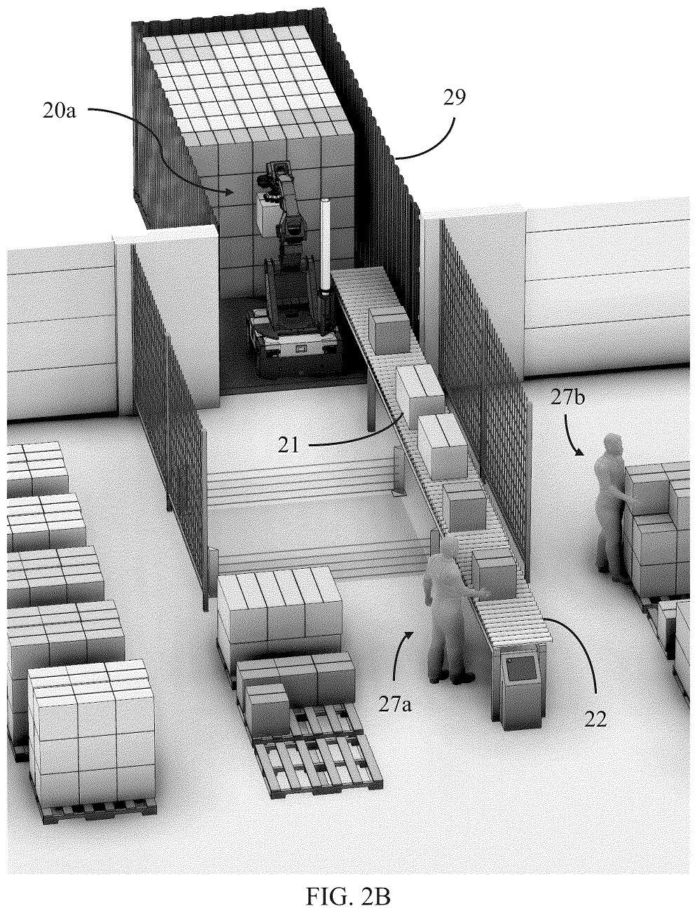

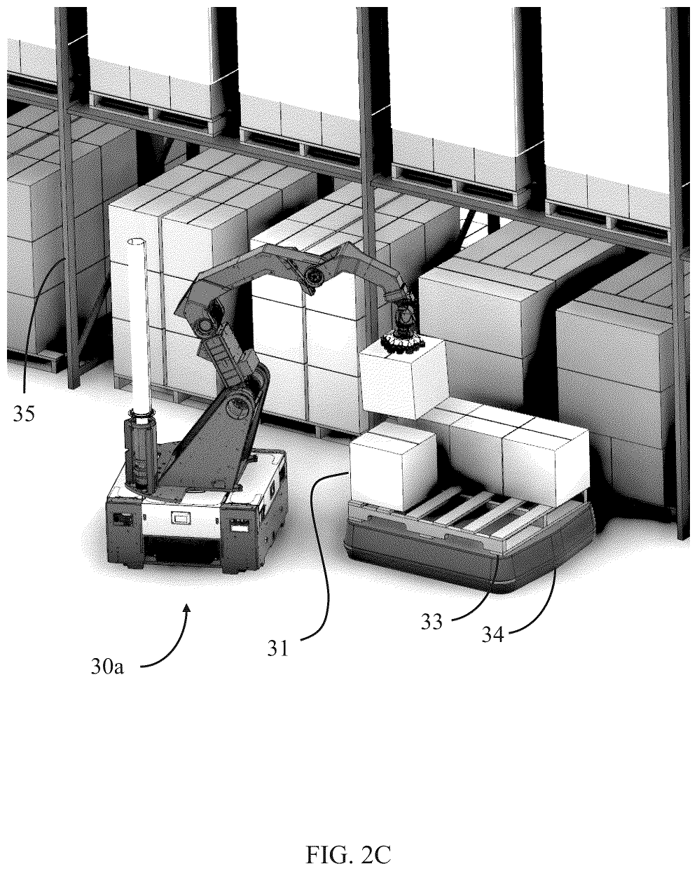

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

### Example Robotic Arm

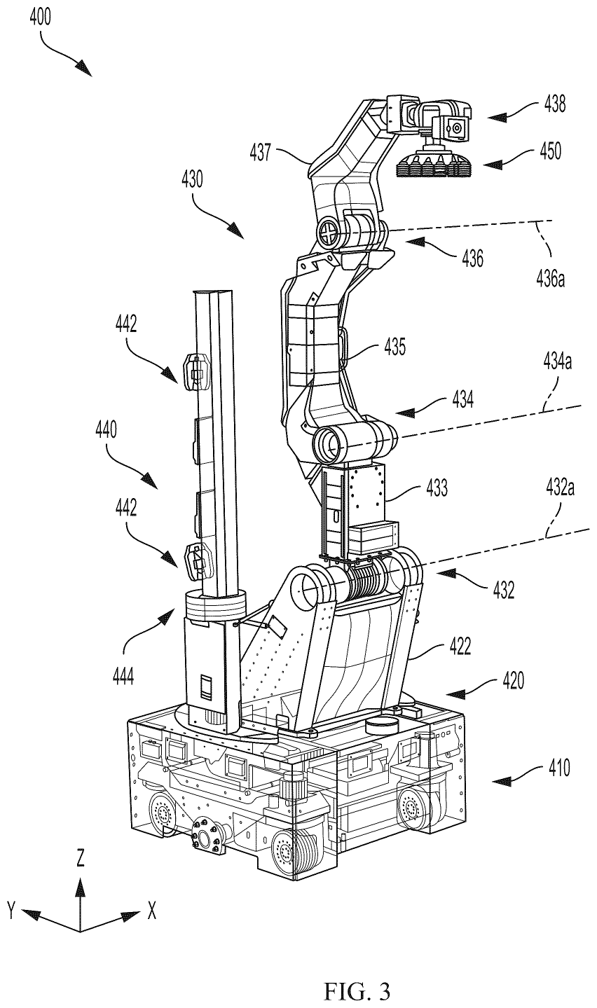

FIG. 3 is a perspective view of a robot 400, according to an illustrative embodiment of the invention. The robot 400 includes a mobile base 410 and a turntable 420 rotatably coupled to the mobile base. A robotic arm 430 is operatively coupled to the turntable 420, as is a perception mast 440. The perception mast 440 includes an actuator 444 configured to enable rotation of the perception mast 440 relative to the turntable 420 and/or the mobile base 410, so that a direction of the perception modules 442 of the perception mast may be independently controlled.

The robotic arm 430 of FIG. 3 is a 6-DOF robotic arm. When considered in conjunction with the turntable 420 (which is configured to yaw relative to the mobile base about a vertical axis parallel to the Z axis), the arm/turntable system may be considered a 7-DOF system. The 6-DOF robotic arm 430 includes three pitch joints 432, 434, and 436, and a 3-DOF wrist 438 which, in some embodiments, may be a spherical 3-DOF wrist.

Starting at the turntable 420, the robotic arm 430 includes a turntable offset 422, which is fixed relative to the turntable 420. A distal portion of the turntable offset 422 is rotatably coupled to a proximal portion of a first link 433 at a first joint 432. A distal portion of the first link 433 is rotatably coupled to a proximal portion of a second link 435 at a second joint 434. A distal portion of the second link 435 is rotatably coupled to a proximal portion of a third link 437 at a third joint 436. The first, second, and third joints 432, 434, and 436 are associated with first, second, and third axes 432a, 434a, and 436a, respectively.

The first, second, and third joints 432, 434, and 436 are additionally associated with first, second, and third actuators (not labeled) which are configured to rotate a link about an axis. Generally, the nth actuator is configured to rotate the nth link about the nth axis associated with the nth joint. Specifically, the first actuator is configured to rotate the first link 433 about the first axis 432a associated with the first joint 432, the second actuator is configured to rotate the second link 435 about the second axis 434a associated with the second joint 434, and the third actuator is configured to rotate the third link 437 about the third axis 436a associated with the third joint 436. In the embodiment shown in FIG. 3, the first, second, and third axes 432a, 434a, and 436a are parallel (and, in this case, are all parallel to the X axis). In the embodiment shown in FIG. 3, the first, second, and third joints 432, 434, and 436 are all pitch joints.

In some embodiments, a robotic arm of a highly integrated mobile manipulator robot may include a different number of degrees of freedom than the robotic arms discussed above. Additionally, a robotic arm need not be limited to a robotic arm with three pitch joints and a 3-DOF wrist. A robotic arm of a highly integrated mobile manipulator robot may include any suitable number of joints of any suitable type, whether revolute or prismatic. Revolute joints need not be oriented as pitch joints, but rather may be pitch, roll, yaw, or any other suitable type of joint.

Returning to FIG. 3, the robotic arm 430 includes a wrist 438. As noted above, the wrist 438 is a 3-DOF wrist, and in some embodiments may be a spherical 3-DOF wrist. The wrist 438 is coupled to a distal portion of the third link 437. The wrist 438 includes three actuators configured to rotate an end effector 450 coupled to a distal portion of the wrist 438 about three mutually perpendicular axes. Specifically, the wrist may include a first wrist actuator configured to rotate the end effector relative to a distal link of the arm (e.g., the third link 437) about a first wrist axis, a second wrist actuator configured to rotate the end effector relative to the distal link about a second wrist axis, and a third wrist actuator configured to rotate the end effector relative to the distal link about a third wrist axis. The first, second, and third wrist axes may be mutually perpendicular. In embodiments in which the wrist is a spherical wrist, the first, second, and third wrist axes may intersect.

In some embodiments, an end effector may be associated with one or more sensors. For example, a force/torque sensor may measure forces and/or torques (e.g., wrenches) applied to the end effector. Alternatively or additionally, a sensor may measure wrenches applied to a wrist of the robotic arm by the end effector (and, for example, an object grasped by the end effector) as the object is manipulated. Signals from these (or other) sensors may be used during mass estimation and/or path planning operations. In some embodiments, sensors associated with an end effector may include an integrated force/torque sensor, such as a 6-axis force/torque sensor. In some embodiments, separate sensors (e.g., separate force and torque sensors) may be employed. Some embodiments may include only force sensors (e.g., uniaxial force sensors, or multi-axis force sensors), and some embodiments may include only torque sensors. In some embodiments, an end effector may be associated with a custom sensing arrangement. For example, one or more sensors (e.g., one or more uniaxial sensors) may be arranged to enable sensing of forces and/or torques along multiple axes. An end effector (or another portion of the robotic arm) may additionally include any appropriate number or configuration of cameras, distance sensors, pressure sensors, light sensors, or any other suitable sensors, whether related to sensing characteristics of the payload or otherwise, as the disclosure is not limited in this regard.

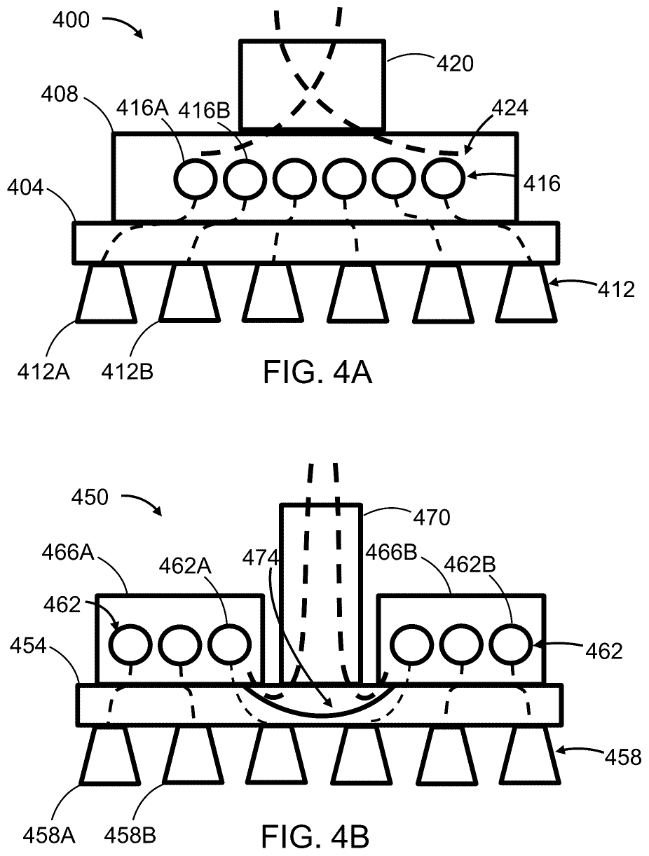

FIGS. 4A-4B are schematic illustrations of modular vacuum grippers 400, 450 according to illustrative embodiments of the invention. FIGS. 4A-4B include dotted lines schematically illustrating vacuum flow paths through the modular vacuum grippers 400, 450 from a vacuum source (not shown). Referring to FIG. 4A, the modular vacuum gripper 400 includes a first modular component 404 and a second modular component 408. The first modular component 404 includes a set of deformable members 412 (e.g., individual deformable members 412A, 412B, etc. as shown). The second modular component 408 includes a set of vacuum valves 416 (e.g., individual vacuum valves 416A, 416B, etc. as shown). Each vacuum valve in the set of vacuum valves 416 is fluidly connected to one deformable member in the set of deformable members 412 (although in some embodiments a vacuum valve can be connected to more than one deformable member). Also shown in FIG. 4A is a connector 420, which in some embodiments is configured to pass vacuum from the vacuum source to the second modular component 408.

During operation, vacuum flows into an open space 424 of the second modular component 408 and is distributed into the vacuum valves 416. In some embodiments, portions of the connector 420 and/or the second modular component 408 may define a plenum region, which may be generally understood to refer to the spatial region to which vacuum first travels from the vacuum source. Vacuum then passes from the second modular component 408 to the first modular component 404 (e.g., via a set of air channels defined, at least in part, by the first modular component 404). Vacuum then passes into the deformable members 412, which enables the gripper 400 to adhere objects, such as boxes or other parcels, and/or release the objects as desired (e.g., as part of a pick-and-place operation) when vacuum is shut off or reduced.

FIG. 4B shows a schematic illustration of a modular vacuum gripper 450 that has some similar features to the modular vacuum gripper 400, including a first modular component 454 that includes the set of deformable members 458 (e.g., 458A, 458B, etc. as shown). However, the modular vacuum gripper 450 has notable differences. First, the vacuum valves 462 (e.g., 462A, 462B, etc. as shown) are provided in two separate modular components 466A, 466B instead of a single modular component 408 shown in FIG. 4A. Second, the connector 470 connects directly to the first modular component 454, which includes a recessed region 474 that provides a pathway for vacuum to enter the two modular components 466A, 466B. In some embodiments, the modular vacuum gripper 450 provides greater flexibility in separating structural elements of the modular vacuum gripper from vacuum-routing elements of the modular vacuum gripper. In some embodiments, the first modular component 454 can include a substantial amount of unused area and/or height, which can be used to route vacuum to the vacuum valves 462 without increasing the overall height of the modular vacuum gripper 450. In some embodiments, using the modular vacuum gripper 450 as a conduit for bridging the connector 470 and the vacuum valves 462 provides an advantage of only having to seal against air leaks on a single flat surface, as opposed to two angled surfaces. In some embodiments, the modular vacuum gripper 450 can simplify manufacturing and/or reduce cost by providing two simpler modular components 466A, 466B in place of one more complex modular component 408. In some embodiments, rather than using the recessed region 474, the connector 470 may connect directly (e.g., laterally left and right, as shown) to the modular components 466A, 466B to provide vacuum thereto.

In some embodiments, a “modular component” (e.g., the first modular component 404, the second modular component 408, etc.) is a component that is configured to be physically separable from other components of the modular vacuum gripper 400 (e.g., during servicing operations). For example, a modular component may be configured to be non-destructively removed from another component (e.g., another modular component) using one or more fasteners (e.g., screws, bolts) to, for instance, facilitate selective removal and/or replacement of the modular component. In some embodiments, the modular component may be configured with a “quick disconnect” feature that enables the modular component to be reversibly decoupled from another component (e.g., another modular component). For instance, the quick disconnect feature may enable the modular component to be decoupled from another component using a small number of operations relative to the number of functional modules within the modular component and/or the another component. In the example of the modular vacuum grippers described herein, the quick disconnect feature may enable a relatively small number (e.g., less than 10, less than 5) of operations to decouple the first modular component from the second modular component despite the number of physical functional structures (e.g., vacuum valves, air distribution channels) formed within one or both of the modular components being substantially larger (e.g., greater than 20, greater than 30, greater than 40, greater than 50, greater than 100). In some embodiments, compartmentalizing separate functionality into a number of discrete modules (e.g., one module including valves and one module including air distribution channels) helps to support streamlined service, replacement, and/or maintenance. In some embodiments, a modular component includes at least a certain number of sub-components supporting a given function of the modular component. For example, the first modular component 404 may include at least a certain number of separate air distribution channels (e.g., two, five, ten, or another integer number greater than one). As another example, the second modular component 408 may include at least a certain number of separate vacuum valves (e.g., two, five, ten, or another integer number greater than one). In some embodiments, the first modular component 404 and/or the second modular component 408 include a different number of physically distinct modules (e.g., two, three, or another integer number greater than zero), as shown, for example, by the modules 466A, 466B in FIG. 4B. In general, the number of modules supporting similar functionality may be made as low as practicable, given the other constraints relevant to any particular vacuum gripper design.

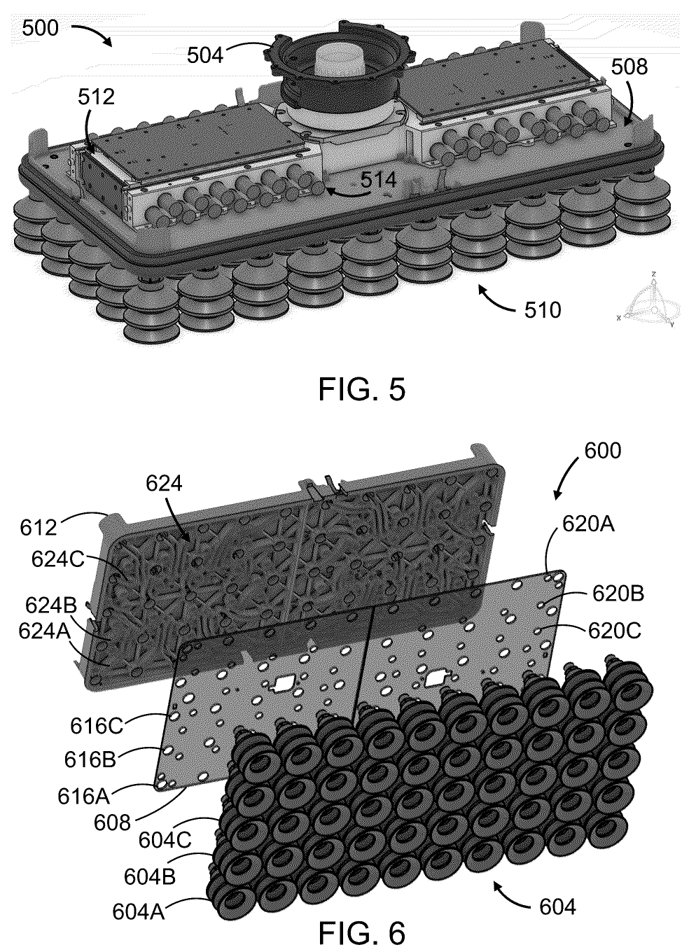

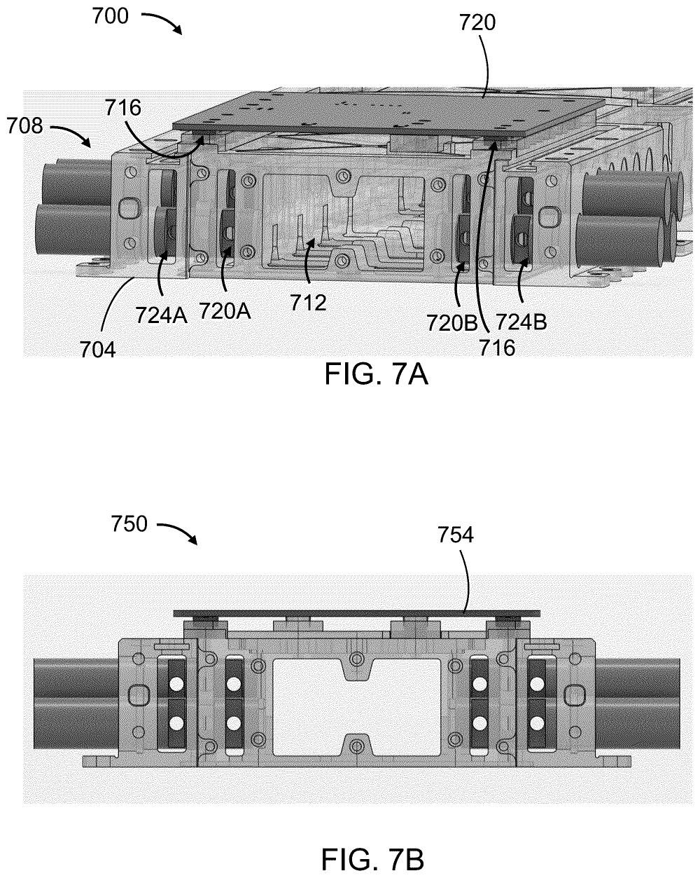

FIG. 5 is a schematic illustration of another modular vacuum gripper 500, according to an illustrative embodiment of the invention. The modular vacuum gripper 500 includes a connector 504 (e.g., a hub or wrist connection), a first modular component 508 having a set of deformable members 510, and a second modular component 512 having a set of vacuum valves 514 (e.g., as shown and described above in FIGS. 4A-4B). In the figures below, the deformable members 510 are often depicted and/or referred to as “vacuum cups”, although one having skill in the art will appreciate that other deformable members (e.g., foam members) may be used instead of or in addition to vacuum cups. The connector 504 can be configured to pass vacuum (e.g., from a vacuum source), electrical signals, and/or power to the modular vacuum gripper 500. The first modular component 508 includes airtight channels that pass vacuum from the second modular component 512. The second modular component 512 includes vacuum valves that mediate vacuum flow from the connector 504 to the first modular component 508. Further details of the first modular component 508 are shown and described below in FIG. 6, and further details of the second modular component 512 are shown and described below in FIGS. 7A-7B. Certain details are not shown in FIG. 5 to reduce visual clutter (e.g., certain structural members and/or electronic components), but such details are shown and described below.

FIG. 6 is an exploded schematic illustration of a first modular component 600 (e.g., the first modular component 508 shown and described above in FIG. 5) for a modular vacuum gripper, according to an illustrative embodiment of the invention. The first modular component 600 includes a set of vacuum cups 604 (e.g., including individual vacuum cups 604A, 604B, 604C, etc., as shown), a seal plate 608 and a monolithic member 612. Vacuum cups in the set of vacuum cups 604 can be made of rubber, deformable plastic, or another suitable material. The seal plate 608 can be made of one or more suitable materials, e.g., a plastic, a metal, and/or metal alloy. The monolithic member 612 can be made of one or more suitable materials, e.g., a plastic, a metal, and/or a metal alloy.

In some embodiments, the set of vacuum cups 604 can attach to (e.g., screw into) the monolithic member 612. In some embodiments, the seal plate 608 can be held in place between the set of vacuum cups 604 and the monolithic member 612 via a first set of holes 616 (e.g., larger circular holes 616A, 616B, 616C, etc. as shown). In some embodiments, a second set of holes 620 (e.g., smaller circular holes 620A, 620B, etc. as shown) can be used to permit screws to attach the first modular component 600 to a second modular component (e.g., the second modular component 700 shown and described below in FIGS. 7A-7B). When assembled, the first modular component 508 defines, at least in part, a set of channels 624 (e.g., individual channels 624A, 624B, 624C, etc. as shown) through which vacuum may flow. Each channel in the set of channels 624 defines, at least in part, a fluid connection between at least one valve in the set of vacuum valves (e.g., the set of vacuum valves 514 as shown above in FIG. 5 or the set of vacuum valves 708 as shown below in FIGS. 7A-7B) and at least one cup in the set of vacuum cups 604. The first modular component 600 can interface to other components (e.g., other modular components), directly or indirectly (e.g., to valves in the second modular component 512 shown and described above in FIG. 5). In the case of a direct connection between a modular component and another component, the two components may be arranged in rigid contact with one another, may have fixed/forceable coupling or the like, with relative positioning such that holes formed in the components (e.g., larger holes 616A, 616B, 616C or smaller holes 620A, 620B, 620C) are aligned to enable coupling of the two components using fasteners.

In some embodiments, the monolithic member 612 substantially defines the boundaries of the air channels 624, except for a boundary defined by the seal plate 608 (or a gasket, with a similar footprint, which is not shown but may be stacked, for example, between the monolithic member 612 and the seal plate 608). However, other arrangements are also possible. For example, in some embodiments, the monolithic member 612 includes a set of bores that span an entire width of the monolithic member. In such embodiments, air channels may be formed by enclosing the monolithic member 612 with the seal plate 608 (or gasket) on one side, and with another similar member (not shown) on the opposite side. In some embodiments, the seal plate 608 is fastened between a first modular component (e.g., the second modular component 512 shown and described above in FIG. 5) and the monolithic member 612. In some embodiments, the set of vacuum cups 604 fastens directly into the monolithic member 612 (e.g., via one or more holes). In some circumstances, such monolithic members may be easier to manufacture through conventional operations, such as milling, casting or injection molding. In some embodiments, such monolithic members may permit air channels to cross over each other. In some embodiments, the monolithic member 612 can be formed by additive manufacturing (e.g., 3D printing), in which case no seal plate may be needed. In some embodiments, the monolithic nature of the monolithic member 612 itself may promote modularity of the first modular component 500 by, for example, not requiring each vacuum cup of the first modular component to be coupled to a respective vacuum valve in another component to which it is coupled using individual passages (e.g., tubes).

FIG. 7A is a perspective view schematic illustration of a second modular component 700 (e.g., the second modular component 512 shown and described above in FIG. 5) for a modular vacuum gripper, according to an illustrative embodiment of the invention. FIG. 7B is a side view schematic illustration of a second modular component 750 for a modular vacuum gripper, according to an illustrative embodiment of the invention. Certain components in FIGS. 7A-7B view are omitted (e.g., electronics on top of the circuit board 754) to reduce visual clutter. The second modular component 700 can include a structural member 704 (e.g., a post-machined extrusion) configured to hold each vacuum valve in the set of vacuum valves 708 in a fixed position relative to the other valves during operation.

In FIGS. 7A-7B, the set of vacuum valves 708 is positioned in a corresponding set of openings (e.g., circular holes) in the structural member 704, which situates the set of vacuum valves 708 in a tightly-packed arrangement that fits multiple vacuum valves in a relatively small volume. In some embodiments, different arrangements (e.g., number of rows, number of vacuum valves, amount of spacing, and/or geometry of packing) are possible. The structural member 704 can include a channel 712 that permits vacuum flow to enter the structural member 704 through each valve in the set of vacuum valves 708. In some embodiments, each vacuum valve in the set of vacuum valves 708 is fluidly connected to at least one vacuum cup (e.g., one, two, three, or more vacuum cups, corresponding to different vacuum “zones”) in the set of vacuum cups (e.g., the set of vacuum cups 510 shown and described above in FIG. 5). In some embodiments, the channel 712 is fluidly connected to a first side channel 720A and a second side channel 720B, into which the vacuum valves 708 can be plumbed. In some embodiments, two additional side channels 724A, 724B provide each of the vacuum valves 708 with access to atmospheric pressure (e.g., so that the vacuum cups can be flushed with air when it is time to release the object being grasped).

In some embodiments, such as the one shown in FIG. 7A, a set of pressure sensors 716 is positioned above each vacuum valve in the set of vacuum valves 708. (Note that in FIG. 7A, only the four vacuum valves closest to the front are rendered to reduce visual clutter, but a similar vacuum valve can be understood to occupy each of the similarly sized circular openings in the structural member 704.) In FIG. 7A, each pressure sensor in the set of pressure sensors 716 is soldered to a single circuit board 720, together with other electronic components, although different arrangements are possible. Each pressure sensor in the set of pressure sensors 716 can be configured to sense a pressure associated with a respective vacuum valve in the set of vacuum valves 708 (or a respective vacuum cup or vacuum zone, e.g., in embodiments in which there is not a 1:1 relationship between pressure sensors and vacuum valves). Each pressure sensor in the set of pressure sensors 716 can be mounted above (e.g., vertically above) a respective vacuum valve in the set of vacuum valves 708.

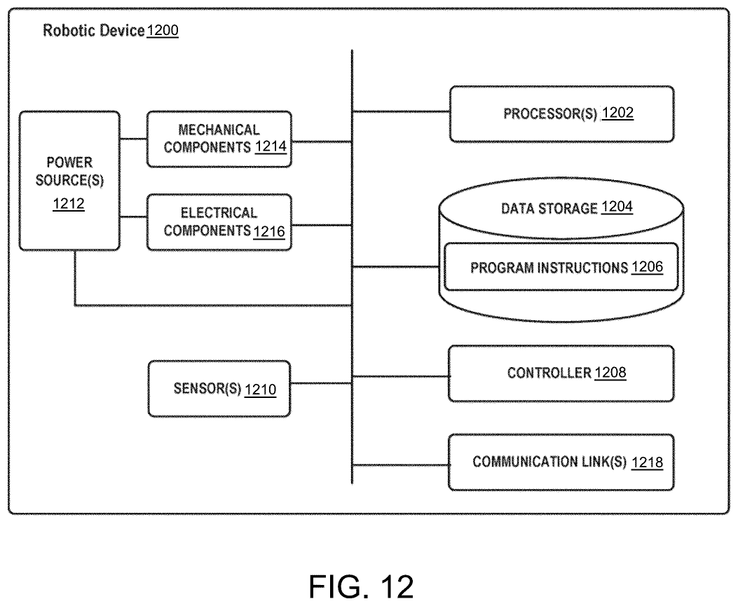

In some embodiments, a controller (e.g., the controller 1208 shown and described below in FIG. 12) is configured to selectively control an amount of vacuum supplied by each vacuum valve in the set of vacuum valves 708 (e.g., turn “on”, in which case the valve may be open to vacuum, or turn “off”, in which case the valve may be open to atmosphere). In some embodiments, each vacuum valve in the set of vacuum valves 708 is configured to actuate to adjust an amount of vacuum in the vacuum valve (e.g., a one-stage valve setup). In some embodiments, each vacuum valve is fluidly connected to a corresponding control valve, each control valve being configured to actuate a respective vacuum valve to adjust an amount of vacuum in the vacuum valve (e.g., a two-stage valve setup). In some embodiments, each vacuum valve in the set of vacuum valves 708 comprises a poppet valve and/or a solenoid.

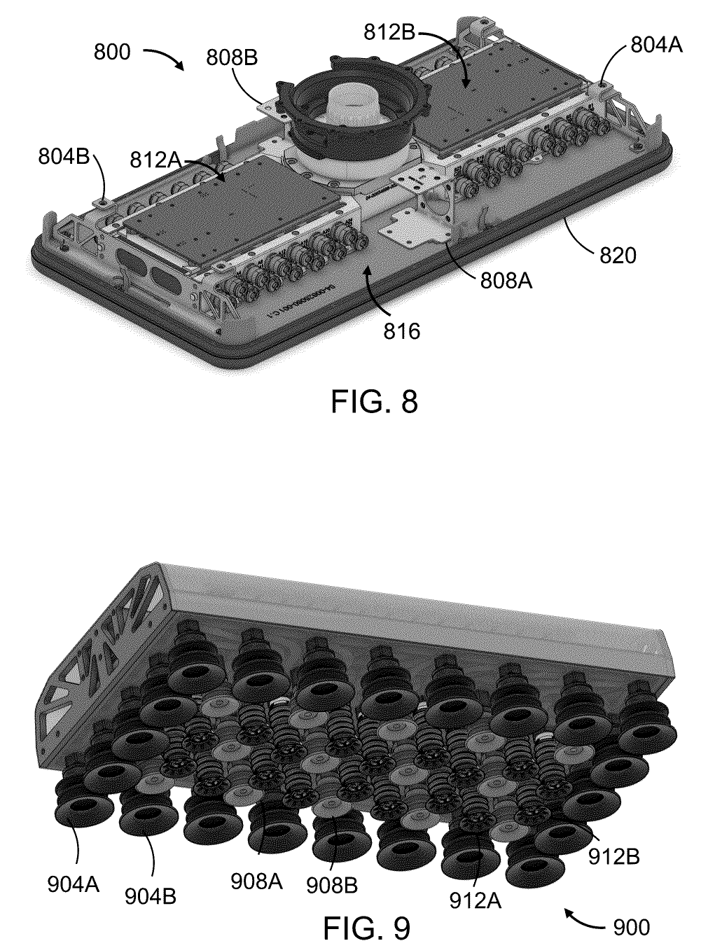

FIG. 8 is a schematic illustration of another modular vacuum gripper 800, according to an illustrative embodiment of the invention. The modular vacuum gripper 800 can be similar to the modular vacuum gripper 500 shown and described above in FIG. 5, with notable differences. For example, in FIG. 8, additional structural members are depicted, such as front and rear structural members 804A, 804B and lateral structural members 808A, 808B. The additional structural members 804A, 804B, 808A, 808B provide a space to which an outer casing (not shown) can mount, which can provide additional protection to the mechanism, safety benefits, and/or aesthetic appeal. Note that in FIG. 8 the set of vacuum cups is not depicted to reduce visual clutter. Also note that in FIG. 8, although the modular components 812A, 812B, 816 serve as structural elements, one having ordinary skill in the art will appreciate that all components could also be enclosed in a separate shell to function as a structural element (e.g., to protect the modular components 812A, 812B, and/or 816 from potential impact). FIG. 8 also shows a bumper 820, which can provide benefits to protect the interior structure from bumps, shocks, wear, and the like. In some embodiments, an outer casing (not shown) for the modular vacuum gripper 800 can provide similar benefits. In some embodiments, the bumper 820 and/or an outer casing (not shown) can be designed to be easily replaceable (e.g., because they are expected to experience wear during normal operation).

FIG. 9 is a schematic illustration of an underside of a modular vacuum gripper 900 having different types of vacuum cups, according to an illustrative embodiment of the invention. The modular vacuum gripper 900 includes three groups of vacuum cups: a first group of vacuum cups 904 (e.g., including individual vacuum cups 904A, 904B, etc. as depicted); a second group of vacuum cups 908 (e.g., including individual vacuum cups 908A, 908B, etc. as depicted); and a third group of vacuum cups 912 (e.g., including individual cups 912A, 912B, etc. as depicted). Vacuum cup groups may differ in at least one of size (e.g., height or diameter), shape (e.g., a number of bellows) or material (e.g., having a different material stiffness) of the constituent vacuum cups. Such a “hybrid” arrangement can have advantages. For example, in some embodiments, cups in the first group of vacuum cups 904 can be optimized to provide a greater moment when engaged to counteract forces and/or torques of adhered parcels. In some embodiments, cups in the second group of vacuum cups 908 can be optimized for adhering to a particular kind of material present in (e.g., on the surface of) one or more parcels to be moved (e.g., cardboard). In some embodiments, cups in the third group of vacuum cups 912 can be optimized for adhering to another kind of material expected to be present in (e.g., on the surface of) one or more parcels to be moved (e.g., cellophane). In some embodiments, when two or more types of surface materials are expected to be encountered during sequential pick-and-place operations, using a hybrid gripper can streamline operations and/or increase the amount of parcels that can be moved per unit time.

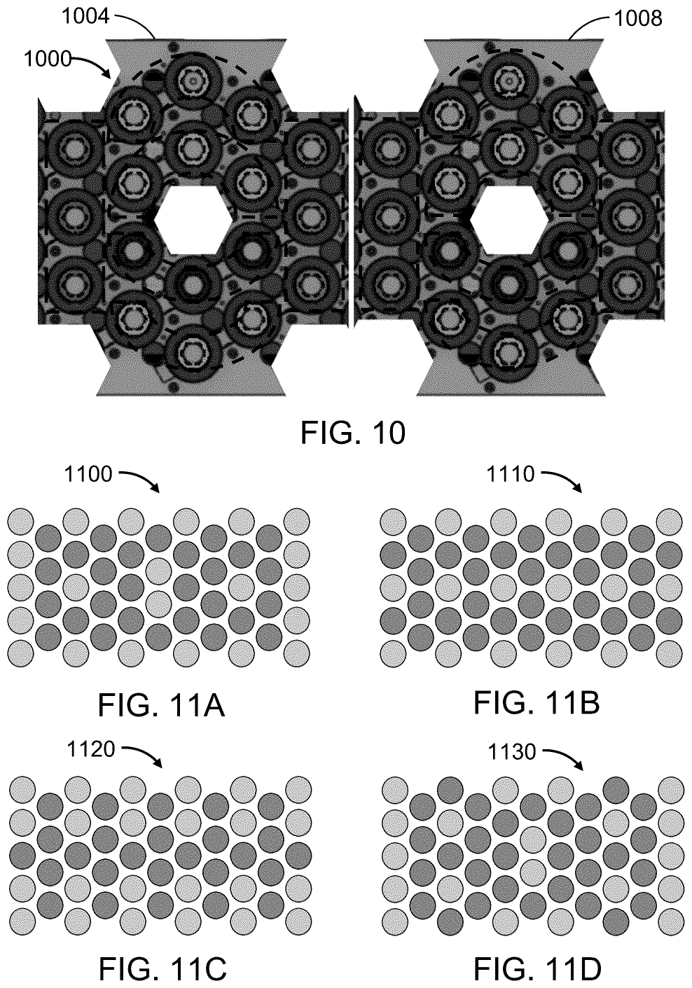

FIG. 10 is a schematic illustration of a cup arrangement on an underside of another modular vacuum gripper 1000 having different zones of vacuum cups, according to an illustrative embodiment of the invention. In FIG. 10, two separate hexagonal platforms 1004, 1008 each comprise 18 vacuum cups, which are spread across six vacuum zones (indicated with dotted lines) each including three vacuum cups. For example, platform 1004 includes six vacuum zones, each including three vacuum cups, and platform 1008 has six vacuum zones, each including three vacuum cups. A vacuum “zone” may correspond to a set of vacuum cups that is fluidly connected to one vacuum valve. One having ordinary skill in the art will readily appreciate that a vacuum zone may include another number of vacuum cups besides three, such as one, two, five, or another integer number that is one or greater.

FIGS. 11A-D are schematic illustrations 1100, 1110, 1120, 1130 of possible cup arrangements of different types of vacuum cups for a modular vacuum gripper (e.g., “hybrid” cup arrangements), according to an illustrative embodiment of the invention. In each of FIGS. 11A-D, two groups of cups are visually distinguished. In some embodiments, groups differ in at least one of size, shape, or material. In FIG. 11A, cups in the first group (e.g., a first combination of characteristics including size, shape, and material) surround the perimeter and have an otherwise limited appearance throughout the interior of the gripper area, whereas cups in the second group (e.g., a second combination of characteristics including size, shape and material different from the first) appear more frequently within an interior area of the covered area. In such an arrangement, cups of the first type may be configured to have a higher stiffness and/or gripping area, so as to provide a higher moment to react forces and/or torques provided by grasped parcels (e.g., as described above), whereas cups of the second type may be customized to grasp a particular material in or expected to be in (e.g., on a surface of) one or more parcels to be grasped. Other arrangements providing this same advantage are also possible, such as those shown in FIGS. 11B-D. In FIG. 11B, cups of one type are spaced at regular intervals in three horizontal rows across the gripping area, whereas cups of another type are spread throughout the areas between the rows. In FIG. 11C, cups of one type mostly dominate the perimeter, although cups of the second type are occasionally present. In FIG. 11D, cups of one type dominate bookend columns of cups at both ends, but otherwise cups are more evenly interspersed. In some embodiments, having different types of cups interspersed throughout the platform provides more flexibility to accommodate different sizes and/or shapes of objects to be grasped (e.g., to provide the advantage of the first cup type when the size of the object is less than the size of the overall size of the gripper).

FIG. 12 illustrates an example configuration of a robotic device 1200, according to an illustrative embodiment of the invention. An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device).

In some implementations, the robotic device may include force sensors that measure or estimate the external forces (e.g., the force applied by a limb of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

FIG. 12 illustrates an example configuration of a robotic device (or “robot”) 1200, according to an illustrative embodiment of the invention. The robotic device 1200 represents an example robotic device configured to perform the operations described herein. Additionally, the robotic device 1200 may be configured to operate autonomously, semi-autonomously, and/or using directions provided by user(s), and may exist in various forms, such as a humanoid robot, biped, quadruped, or other mobile robot, among other examples. Furthermore, the robotic device 1200 may also be referred to as a robotic system, mobile robot, or robot, among other designations.

As shown in FIG. 12, the robotic device 1200 includes processor(s) 1202, data storage 1204, program instructions 1206, controller 1208, sensor(s) 1210, power source(s) 1212, mechanical components 1214, and electrical components 1216. The robotic device 1200 is shown for illustration purposes and may include more or fewer components without departing from the scope of the disclosure herein. The various components of robotic device 1200 may be connected in any manner, including via electronic communication means, e.g., wired or wireless connections. Further, in some examples, components of the robotic device 1200 may be positioned on multiple distinct physical entities rather on a single physical entity. Other example illustrations of robotic device 1200 may exist as well.

Processor(s) 1202 may operate as one or more general-purpose processor or special purpose processors (e.g., digital signal processors, application specific integrated circuits, etc.). The processor(s) 1202 can be configured to execute computer-readable program instructions 1206 that are stored in the data storage 1204 and are executable to provide the operations of the robotic device 1200 described herein. For instance, the program instructions 1206 may be executable to provide operations of controller 1208, where the controller 1208 may be configured to cause activation and/or deactivation of the mechanical components 1214 and the electrical components 1216. The processor(s) 1202 may operate and enable the robotic device 1200 to perform various functions, including the functions described herein.

The data storage 1204 may exist as various types of storage media, such as a memory. For example, the data storage 1204 may include or take the form of one or more computer-readable storage media that can be read or accessed by processor(s) 1202. The one or more computer-readable storage media can include volatile and/or non-volatile storage components, such as optical, magnetic, organic or other memory or disc storage, which can be integrated in whole or in part with processor(s) 1202. In some implementations, the data storage 1204 can be implemented using a single physical device (e.g., one optical, magnetic, organic or other memory or disc storage unit), while in other implementations, the data storage 1204 can be implemented using two or more physical devices, which may communicate electronically (e.g., via wired or wireless communication). Further, in addition to the computer-readable program instructions 1206, the data storage 1204 may include additional data such as diagnostic data, among other possibilities.

The robotic device 1200 may include at least one controller 1208, which may interface with the robotic device 1200. The controller 1208 may serve as a link between portions of the robotic device 1200, such as a link between mechanical components 1214 and/or electrical components 1216. In some instances, the controller 1208 may serve as an interface between the robotic device 1200 and another computing device. Furthermore, the controller 1208 may serve as an interface between the robotic system 1200 and a user(s). The controller 1208 may include various components for communicating with the robotic device 1200, including one or more joysticks or buttons, among other features. The controller 1208 may perform other operations for the robotic device 1200 as well. Other examples of controllers may exist as well.

Additionally, the robotic device 1200 includes one or more sensor(s) 1210 such as force sensors, proximity sensors, motion sensors, load sensors, position sensors, touch sensors, depth sensors, ultrasonic range sensors, and/or infrared sensors, among other possibilities. The sensor(s) 1210 may provide sensor data to the processor(s) 1202 to allow for appropriate interaction of the robotic system 1200 with the environment as well as monitoring of operation of the systems of the robotic device 1200. The sensor data may be used in evaluation of various factors for activation and deactivation of mechanical components 1214 and electrical components 1216 by controller 1208 and/or a computing system of the robotic device 1200.

The sensor(s) 1210 may provide information indicative of the environment of the robotic device for the controller 1208 and/or computing system to use to determine operations for the robotic device 1200. For example, the sensor(s) 1210 may capture data corresponding to the terrain of the environment or location of nearby objects, which may assist with environment recognition and navigation, etc. In an example configuration, the robotic device 1200 may include a sensor system that may include a camera, RADAR, LIDAR, time-of-flight camera, global positioning system (GPS) transceiver, and/or other sensors for capturing information of the environment of the robotic device 1200. The sensor(s) 1210 may monitor the environment in real-time and detect obstacles, elements of the terrain, weather conditions, temperature, and/or other parameters of the environment for the robotic device 1200.

Further, the robotic device 1200 may include other sensor(s) 1210 configured to receive information indicative of the state of the robotic device 1200, including sensor(s) 1210 that may monitor the state of the various components of the robotic device 1200. The sensor(s) 1210 may measure activity of systems of the robotic device 1200 and receive information based on the operation of the various features of the robotic device 1200, such the operation of extendable legs, arms, or other mechanical and/or electrical features of the robotic device 1200. The sensor data provided by the sensors may enable the computing system of the robotic device 1200 to determine errors in operation as well as monitor overall functioning of components of the robotic device 1200.

For example, the computing system may use sensor data to determine the stability of the robotic device 1200 during operations as well as measurements related to power levels, communication activities, components that require repair, among other information. As an example configuration, the robotic device 1200 may include gyroscope(s), accelerometer(s), and/or other possible sensors to provide sensor data relating to the state of operation of the robotic device. Further, sensor(s) 1210 may also monitor the current state of a function that the robotic system 1200 may currently be operating. Additionally, the sensor(s) 1210 may measure a distance between a given robotic limb of a robotic device and a center of mass of the robotic device. Other example uses for the sensor(s) 1210 may exist as well.

Additionally, the robotic device 1200 may also include one or more power source(s) 1212 configured to supply power to various components of the robotic device 1200. Among possible power systems, the robotic device 1200 may include a hydraulic system, electrical system, batteries, and/or other types of power systems. As an example illustration, the robotic device 1200 may include one or more batteries configured to provide power to components via a wired and/or wireless connection. Within examples, components of the mechanical components 1214 and electrical components 1216 may each connect to a different power source or may be powered by the same power source. Components of the robotic system 1200 may connect to multiple power sources as well.

Within example configurations, any type of power source may be used to power the robotic device 1200, such as a gasoline and/or electric engine. Further, the power source(s) 1212 may charge using various types of charging, such as wired connections to an outside power source, wireless charging, combustion, or other examples. Other configurations may also be possible. Additionally, the robotic device 1200 may include a hydraulic system configured to provide power to the mechanical components 1214 using fluid power. Components of the robotic device 1200 may operate based on hydraulic fluid being transmitted throughout the hydraulic system to various hydraulic motors and hydraulic cylinders, for example. The hydraulic system of the robotic device 1200 may transfer a large amount of power through small tubes, flexible hoses, or other links between components of the robotic device 1200. Other power sources may be included within the robotic device 1200.

Mechanical components 1214 can represent hardware of the robotic system 1200 that may enable the robotic device 1200 to operate and perform physical functions. As a few examples, the robotic device 1200 may include actuator(s), extendable leg(s), arm(s), wheel(s), one or multiple structured bodies for housing the computing system or other components, and/or other mechanical components. The mechanical components 1214 may depend on the design of the robotic device 1200 and may also be based on the functions and/or tasks the robotic device 1200 may be configured to perform. As such, depending on the operation and functions of the robotic device 1200, different mechanical components 1214 may be available for the robotic device 1200 to utilize. In some examples, the robotic device 1200 may be configured to add and/or remove mechanical components 1214, which may involve assistance from a user and/or other robotic device.

The electrical components 1216 may include various components capable of processing, transferring, providing electrical charge or electric signals, for example. Among possible examples, the electrical components 1216 may include electrical wires, circuitry, and/or wireless communication transmitters and receivers to enable operations of the robotic device 1200. The electrical components 1216 may interwork with the mechanical components 1214 to enable the robotic device 1200 to perform various operations. The electrical components 1216 may be configured to provide power from the power source(s) 1212 to the various mechanical components 1214, for example. Further, the robotic device 1200 may include electric motors. Other examples of electrical components 1216 may exist as well.

In some implementations, the robotic device 1200 may also include communication link(s) 1218 configured to send and/or receive information. The communication link(s) 1218 may transmit data indicating the state of the various components of the robotic device 1200. For example, information read in by sensor(s) 1210 may be transmitted via the communication link(s) 1218 to a separate device. Other diagnostic information indicating the integrity or health of the power source(s) 1212, mechanical components 1214, electrical components 1218, processor(s) 1202, data storage 1204, and/or controller 1208 may be transmitted via the communication link(s) 1218 to an external communication device.

In some implementations, the robotic device 1200 may receive information at the communication link(s) 1218 that is processed by the processor(s) 1202. The received information may indicate data that is accessible by the processor(s) 1202 during execution of the program instructions 1206, for example. Further, the received information may change aspects of the controller 1208 that may affect the behavior of the mechanical components 1214 or the electrical components 1216. In some cases, the received information indicates a query requesting a particular piece of information (e.g., the operational state of one or more of the components of the robotic device 1200), and the processor(s) 1202 may subsequently transmit that particular piece of information back out the communication link(s) 1218.

In some cases, the communication link(s) 1218 include a wired connection. The robotic device 1200 may include one or more ports to interface the communication link(s) 1218 to an external device. The communication link(s) 1218 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

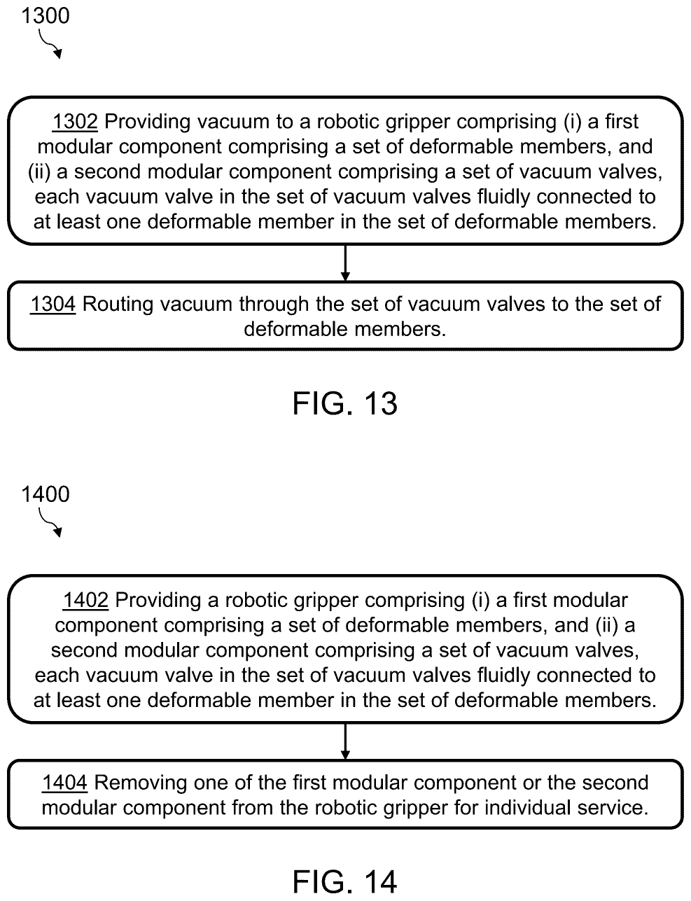

FIG. 13 shows a flow chart 1300 of a method of using a robotic gripper, according to an illustrative embodiment of the invention. In act 1302, vacuum is provided to a robotic gripper comprising: (i) a first modular component comprising a set of deformable members; and (ii) a second modular component comprising a set of vacuum valves, each vacuum valve in the set of vacuum valves fluidly connected to at least one deformable member in the set of deformable members. In act 1304, vacuum is routed through the set of vacuum valves to the set of deformable members. In some embodiments, the robotic gripper lifts an object by establishing a vacuum seal between the object and at least one deformable member in the set of deformable members. In some embodiments, each vacuum valve in the set of vacuum valves is individually controlled. In some embodiments, routing vacuum through the set of vacuum valves to the set of deformable members comprises: (i) routing vacuum from a vacuum source to the set of vacuum valves via a connector of the robotic gripper; and (ii) routing vacuum from the set of vacuum valves to the set of deformable members via a set of channels defined, at least in part by the first modular component.

In some embodiments, a vacuum pulse is applied to each vacuum valve in the set of vacuum valves. In some embodiments, a pressure measurement is determined for each of the vacuum valves, while the vacuum pulse is applied to the vacuum valve and using one or more pressure sensors. In some embodiments, the pressure measurement comprises a rate of change of a pressure signal measured by the one or more pressure sensors and/or a peak pressure value of a pressure signal measured by the one or more pressure sensors. In some embodiments, one or more of the vacuum valves is selectively activated based, at least in part, on the determined pressure measurements for the vacuum valves. In some embodiments, the pressure measurement comprises a time-variant pressure signal measured by the one or more pressure sensors. In some embodiments, one or more vacuum valves in the set of vacuum valves is selectively activated based, at least in part, on one or more characteristics of the determined pressure measurements (e.g., a peak pressure value, an average pressure value, a rate of change of pressure, and/or a comparison of one or more characteristics with other pressure measurements). In some embodiments, a trajectory for the robotic gripper is determined based at least in part on the determined pressure measurements for the vacuum valves. In some embodiments, the pressure measurements are inputs into a kinematic constraint on the trajectory of the robotic gripper (e.g., a maximum allowed torque or wrench).

FIG. 14 shows a flow chart 1400 of a method of servicing a robotic gripper, according to an illustrative embodiment of the invention. In act 1402, vacuum is provided to a robotic gripper comprising: (i) a first modular component comprising a set of deformable members; and (ii) a second modular component comprising a set of vacuum valves, each vacuum valve in the set of vacuum valves fluidly connected to at least one deformable member in the set of deformable members. In act 1404, one of the first modular component or the second modular component is removed from the robotic gripper for individual service.

A number of implementations have been described. Nevertheless, it will be understood that various modifications may be made without departing from the spirit and scope of the disclosure.

1. A robotic gripper comprising:
a first modular component comprising a set of deformable members; and
a second modular component comprising a set of vacuum valves, each vacuum valve in the set of vacuum valves fluidly connected to at least one deformable member in the set of deformable members.

2. The robotic gripper of claim 1 wherein the set of deformable members comprises a set of vacuum cups.

3. The robotic gripper of claim 1 wherein the set of deformable members comprises a set of foam members.

4. The robotic gripper of claim 1 wherein the first modular component further comprises a set of channels, each channel in the set of channels defining, at least in part, a fluid connection between at least one vacuum valve in the set of vacuum valves and at least one deformable member in the set of deformable members.

5. The robotic gripper of claim 4 wherein each channel in the set of channels is defined, at least in part, by a monolithic member having a first surface, a second surface opposite the first surface, and a set of bores.

6. The robotic gripper of claim 1 further comprising a controller configured to individually control an amount of vacuum supplied by each vacuum valve in the set of vacuum valves.

7. The robotic gripper of claim 1 wherein each vacuum valve in the set of vacuum valves is configured to actuate to adjust an amount of vacuum in the vacuum valve.

8. The robotic gripper of claim 1 further comprising a set of pressure sensors, each pressure sensor in the set of pressure sensors configured to sense a pressure associated with (i) a respective vacuum valve in the set of vacuum valves, or (ii) a respective vacuum zone or deformable member.

9. The robotic gripper of claim 8 wherein each pressure sensor in the set of pressure sensors is mounted above a respective vacuum valve in the set of vacuum valves.

10. The robotic gripper of claim 1 wherein the second modular component includes a structural member configured to hold each vacuum valve in the set of vacuum valves.

11. The robotic gripper of claim 1 wherein each vacuum valve in the set of vacuum valves is fluidly connected to one corresponding deformable member in the set of deformable members.

12. The robotic gripper of claim 1 wherein each vacuum valve in the set of vacuum valves is fluidly connected to at least two corresponding deformable members in the set of deformable members.

13. The robotic gripper of claim 1 further comprising at least two groups of deformable members, wherein deformable members in the first group of deformable members differ from deformable members in the second group of deformable members in at least one of size, shape, or material.

14. A robot comprising:
a mobile base;
a robotic arm coupled to the mobile base; and
the robotic gripper of claim 1, the robotic gripper coupled to a distal end of the robotic arm.

15. A method of using a robotic gripper, the method comprising:
providing vacuum to a robotic gripper comprising
a first modular component comprising a set of deformable members; and
a second modular component comprising a set of vacuum valves, each vacuum valve in the set of vacuum valves fluidly connected to at least one deformable member in the set of deformable members; and
routing vacuum through the set of vacuum valves to the set of deformable members.

16. The method of claim 15 further comprising lifting an object using the robotic gripper by:
establishing a vacuum seal between the object and at least one deformable member in the set of deformable members; and
controlling a robotic arm coupled to the robotic gripper to lift the object while the vacuum seal is established.

17. The method of claim 15 further comprising individually controlling each vacuum valve in the set of vacuum valves.

18. The method of claim 15 wherein routing vacuum through the set of vacuum valves to the set of deformable members comprises:
routing vacuum from a vacuum source to the set of vacuum valves via a connector of the robotic gripper;
routing vacuum from the set of vacuum valves to the set of deformable members via a set of channels defined, at least in part, by the first modular component.

19. The method of claim 15 further comprising:
applying a vacuum pulse to each vacuum valve in the set of vacuum valves;
determining, for each of the vacuum valves, while the vacuum pulse is applied to the vacuum valve and using one or more pressure sensors, a pressure measurement for the vacuum valve; and
selectively activating one or more of the vacuum valves based, at least in part, on the determined pressure measurements for the vacuum valves.

20. The method of claim 19 further comprising determining a trajectory for the robotic gripper based, at least in part, on the determined pressure measurements for the vacuum valves.

21. The method of claim 23 wherein the pressure measurement comprises a rate of change of a pressure signal measured by the one or more pressure sensors and/or a peak pressure value of a pressure signal measured by the one or more pressure sensors

22. The method of claim 23 wherein the pressure measurement comprises a time-variant pressure signal measured by the one or more pressure sensors.

23. A method of servicing a robotic gripper, the method comprising:
providing a robotic gripper comprising
a first modular component comprising a set of deformable members; and
a second modular component comprising a set of vacuum valves, each vacuum valve in the set of vacuum valves fluidly connected to at least one deformable member in the set of deformable members; and
removing one of the first modular component or the second modular component from the robotic gripper for individual service.
